(19) United States
(12) Patent Application Publication
(10) Pub. No.: US 2020/0036278 A1
(43) Pub. Date: Jan. 30, 2020

(54) POWER CONVERTER SWITCHABLE BETWEEN DIFFERENT POWER CONVERSION MODES

(71) Applicant: HIWIN MIKROSYSTEM CORP., Taichung (TW)

(72) Inventors: Shou-Liang TSAI, Taichung (TW); Chung-Ming YOUNG, Taichung (TW); Chi-Lin HUANG, Taichung (TW)

(73) Assignee: HIWIN MIKROSYSTEM CORP., Taichung (TW)

(21) Appl. No.: 16/047,510

(22) Filed: Jul. 27, 2018

(51) Int. Cl. H02M 1/00; H02M 3/335; H02M 5/458; H02M 1/088

(52) U.S. Cl. CPC H02M 1/00; H02M 3/33576; H02M 2001/0067; H02M 1/088; H02M 5/4585

(57) ABSTRACT

A power converter includes a mode switch cell which is provided with AC power or DC power, and a converter circuit which has an AC input port and a DC input port. The mode switch cell is operable to relay the AC power to the AC input port or to relay the DC power to the DC input port. The converter circuit is configured to generate a DC power output by performing AC-to-DC conversion on the AC power, or performing DC-to-DC conversion on the DC power.

### FIELD

The disclosure relates to a power converter, and more particularly to a power converter which is switchable between different power conversion modes.

### BACKGROUND

Some conventional converters are configured to perform a specific power conversion (e.g., AC-DC conversion, AC-AC conversion, DC-DC conversion or DC-AC conversion) in a single input-output direction for a specific type of power source and a specific type of load.

### SUMMARY

Therefore, an object of the disclosure is to provide a power converter that is switchable between different power conversion modes in a single input-output direction.

According to one aspect of the disclosure, the power converter includes a mode switch cell and a converter circuit. The mode switch cell includes a power input port disposed to receive one of alternating-current (AC) electric power provided by an AC power source and direct-current (DC) electric power provided by a DC power source, an AC power output port, and a DC power output port. The mode switch cell is operable to couple the power input port to one of the AC power output port and the DC power output port. The converter circuit includes an AC power input port coupled to the AC power output port of the mode switch cell, a DC power input port coupled to the DC power output port of the mode switch cell, and a power output port. The converter circuit is configured to generate a DC power output at the power output port by: performing AC-to-DC conversion on the AC electric power which is received through the AC power input port to generate the DC power output; and performing DC-to-DC conversion on the DC electric power which is received through the DC power input port to generate the DC power output.

According to another aspect of the disclosure, the power converter includes a converter circuit and a mode switch cell. The converter circuit is disposed to receive direct-current (DC) power provided by a DC power source, is configured to generate one of an alternating-current (AC) power output and a DC power output, and includes an AC power output port at which the AC power output is provided, and a DC power output port at which the DC power output is provided. The mode switch cell including an AC power input port coupled to the AC power output port of the converter circuit for receiving the AC power output therefrom, a DC power input port coupled to the DC power output port of the converter circuit for receiving the DC power output therefrom, and a power output port to be coupled to one of an AC load and a DC load. The second mode switch cell is operable to couple the power output port to one of the AC power input port and the DC power input port. The converter circuit is configured to per form DC-to-AC conversion on the DC power to generate the AC power output which is provided to the power output port of the mode switch cell through the AC power input port of the mode switch cell. The converter circuit is configured to perform DC-to-DC conversion on the DC power to generate the DC power output which is provided to the power output port of the mode switch cell through the DC power input port of the mode switch cell.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating an embodiment of the power converter according to the disclosure;

FIG. 2 is a schematic circuit diagram illustrating the embodiment;

FIG. 3 is a schematic diagram illustrating four AC-to-DC operation modes of a single first-stage conversion circuit cell of the embodiment;

FIG. 4 is a schematic diagram illustrating four DC-to-DC operation modes of a single first-stage conversion circuit cell of the embodiment;

FIGS. 5 to 8 are timing diagrams illustrating different operations of the first-stage conversion circuit cell depending on first and second capacitors of the embodiment;

FIG. 9 is a timing diagram illustrating an exemplary DC-to-DC operation of the first-stage conversion circuit cells of the embodiment;

FIG. 10 is a schematic diagram illustrating three AC-to-DC operation modes of a single second-stage conversion circuit cell of the embodiment;

FIG. 11 is a schematic diagram illustrating four DC-to-DC operation modes of a single second-stage conversion circuit cell of the embodiment; and

FIG. 12 is a timing diagram illustrating an exemplary DC-to-DC operation of the second-stage conversion circuit cells of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

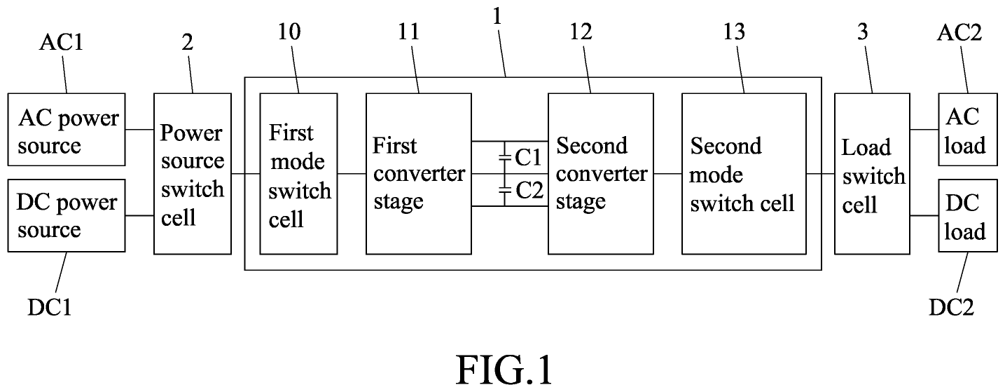

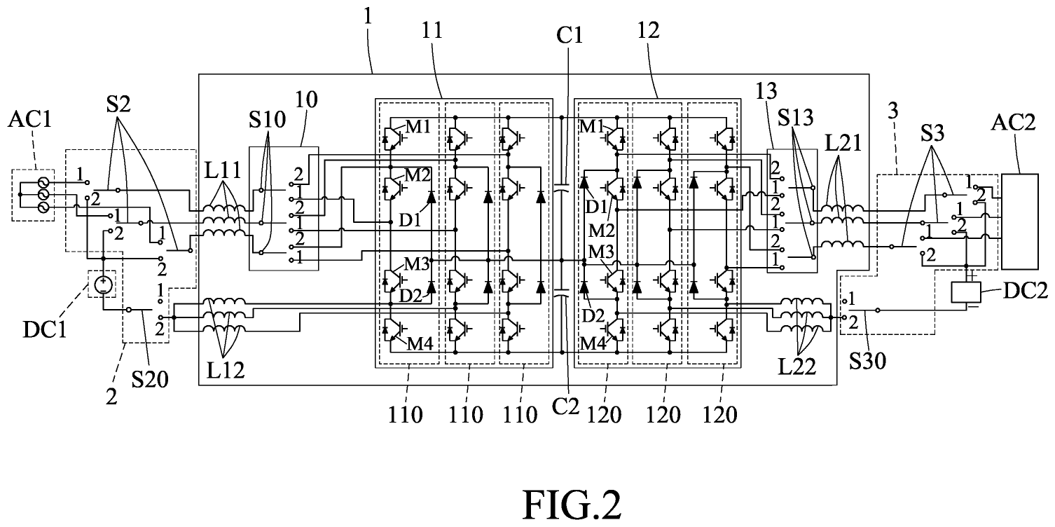

Referring to FIGS. 1 and 2, an embodiment of the power converter according to this disclosure is shown to be coupled to an alternating-current (AC) power source (AC1) and a direct-current (DC) power source (DC1) at an input side thereof, to be coupled to an AC load (AC2) and a DC load (DC2) at an output side thereof, and includes a switchable power converter circuit 1, a power source switch cell 2, and a load switch cell 3. The AC power source (AC1) is an N-phase AC power source that provides AC electric power with a number N of AC power signal(s) each having an individual phase, and the AC load (AC2) is capable of receiving an M-phase AC power input that includes a number M of AC power signal(s) each having an individual phase, where each of N and M is a positive integer. In this embodiment, it is exemplified that N=M=3. The DC power source (DC1) has a first node (+) and a second node (−) that cooperate to provide the DC electric power. The DC load (DC2) has a first node (+) and a second node (−) that cooperate to receive DC electric power from the power converter.

The switchable converter circuit 1 includes a first mode switch cell 10, a first converter stage 11, a second converter stage 12, a second mode switch cell 13, a first capacitor (C1) and a second capacitor (C2).

The first mode switch cell 10 includes a power input port coupled to the power source switch cell 2 for receiving one of the AC electric power provided by the AC power source (AC1) and the DC electric power provided by the DC power source (DC1) therethrough, an AC power output port, and a DC power output port, and is operable to couple the power input port to one of the AC power output port and the DC power output port. In detail, the first mode switch cell 10 includes a number N of first mode switch(es) (S10) each having a first terminal (i.e., the node 1 in FIG. 2), a second terminal (the node 2 in FIG. 2) and a third terminal. The first terminal(s) of the first mode switch(es) (S10) forms (form) the AC power output port of the first mode switch cell 10, the second terminal(s) of the first mode switch(es) (S10) forms(form) the DC power output port of the first mode switch cell 10, and the third terminal(s) of the first mode switch(es) (S10) forms (form) the power input port of the first mode switch cell 10. The third terminal of each first mode switch (S10) is coupled to the power source switch cell 2 for receiving one of the DC electric power provided by the DC power source (DC1) and a respective one of the AC power signal(s). Each first mode switch S10 is operable to couple the third terminal thereof to one of the first terminal thereof and the second terminal thereof. In this embodiment, when the power converter is to perform AC-to-DC or AC-to-AC conversion (i.e., the input side of the power converter is to receive the AC electric power), each first mode switch (S10) is operated to couple the third terminal thereof to the first terminal thereof; and, when the power converter is to perform DC-to-DC or DC-to-AC conversion (i.e., the input side of the power converter is to receive the DC electric power), each first mode switch (S10) is operated to couple the third terminal thereof to the second terminal thereof.

The first capacitor (C1) has a first terminal and a second terminal, and the second capacitor (C2) has a first terminal coupled to the second terminal of the first capacitor (C1), and the second terminal.

The first converter stage 11 includes a DC power input port coupled to the DC power output port of the first mode switch cell 10, an AC power input port coupled to the AC power output port of the first mode switch cell 10, a first-stage output port at which a first-stage DC power output is provided, and a number N of first-stage conversion circuit cell(s) 110. Each first-stage conversion circuit cell 110 includes four transistors (M1, M2, M3, M4) and two diodes (D1, D2).

For each first-stage conversion circuit cell 110, the transistor (M1) has a first terminal coupled to the first terminal of the first capacitor (C1), a second terminal coupled to the second terminal of a respective one of the first mode switch(es) (S10) for receiving the DC electric power therefrom, and a control terminal; the transistor (M2) has a first terminal coupled to the second terminal of the transistor (M1), a second terminal coupled to the first terminal of a respective one of the first mode switch(es) (S10) for receiving a respective one of the AC power signal(s) therefrom, and a control terminal; the transistor (M3) has a first terminal coupled to the second terminal of the transistor (M2), a second terminal, and a control terminal; the transistor (M4) has a first terminal coupled to the second terminal of the transistor (M3), a second terminal coupled to the second terminal of the second capacitor (C2), and a control terminal; the diode (D1) has a cathode coupled to the second terminal of the transistor (M1), and an anode coupled to the second terminal of the first capacitor (C1); the diode (D2) has a cathode coupled to the anode of the diode (D1), and an anode coupled to the second terminal of the transistor (M3). It is noted that, for each first-stage conversion circuit cell 110, the second terminals of the transistors (M1, M2) may be coupled to either the same or different first mode switches (S10), and this disclosure is not limited in this respect.

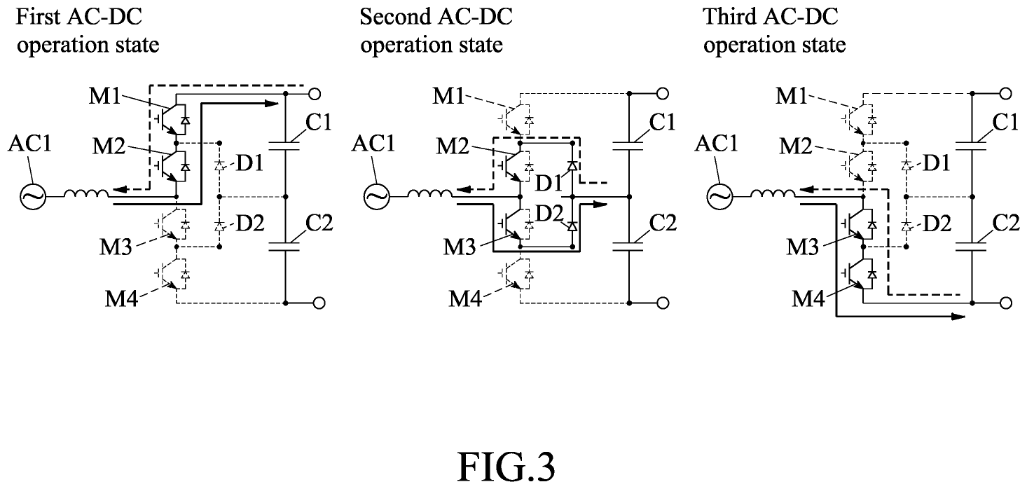

The first converter stage 11 cooperates with the first and second capacitors (C1, C2) to perform AC-to-DC conversion on the AC power signals which are received through the AC power input port (formed by the second terminal(s) of the transistor(s) (M2)) to generate the first-stage DC power output at the first-stage output port (formed by the first terminal(s) of the transistor(s) (M1) and the second terminal(s) of the transistor(s) (M4)). In such a case, the first converter stage 11 operates as a synchronous rectifier and power factor correction circuit, and a single first-stage conversion circuit cell 110 may operate in three operation states as shown in FIG. 3.

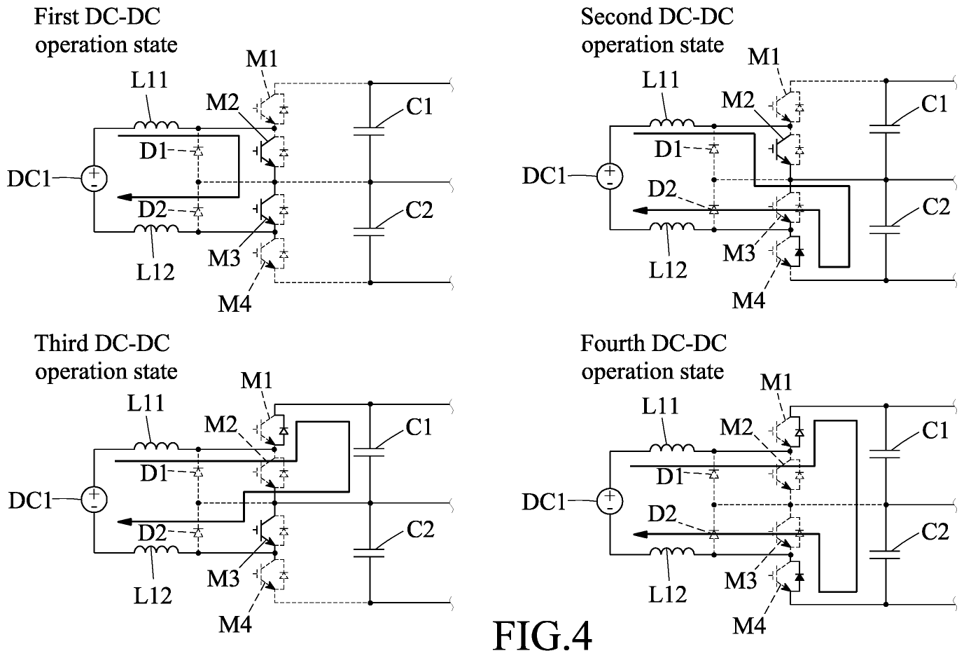

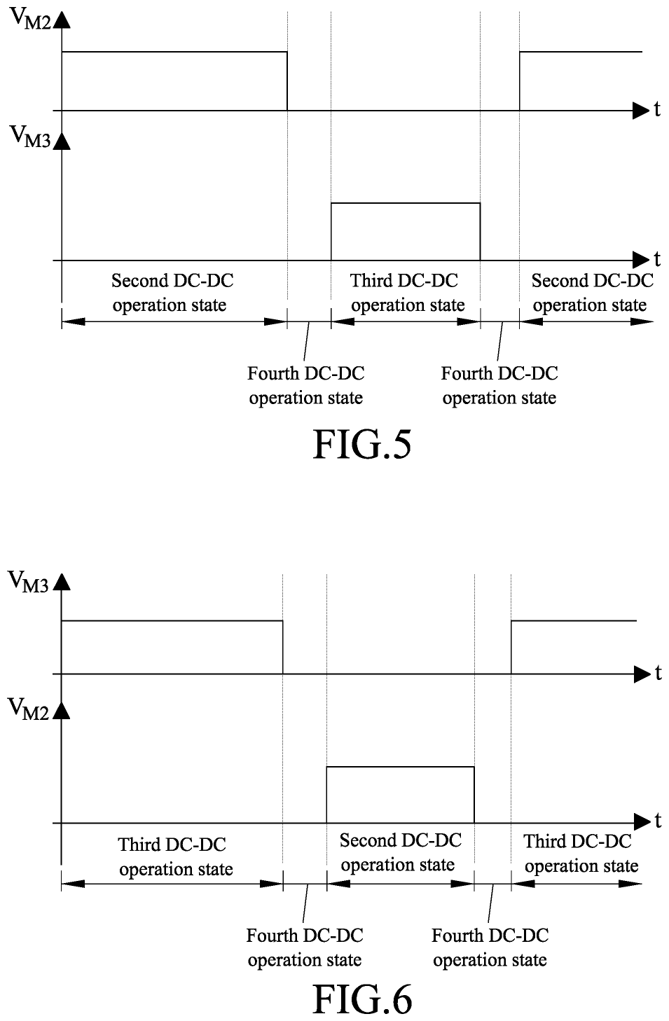

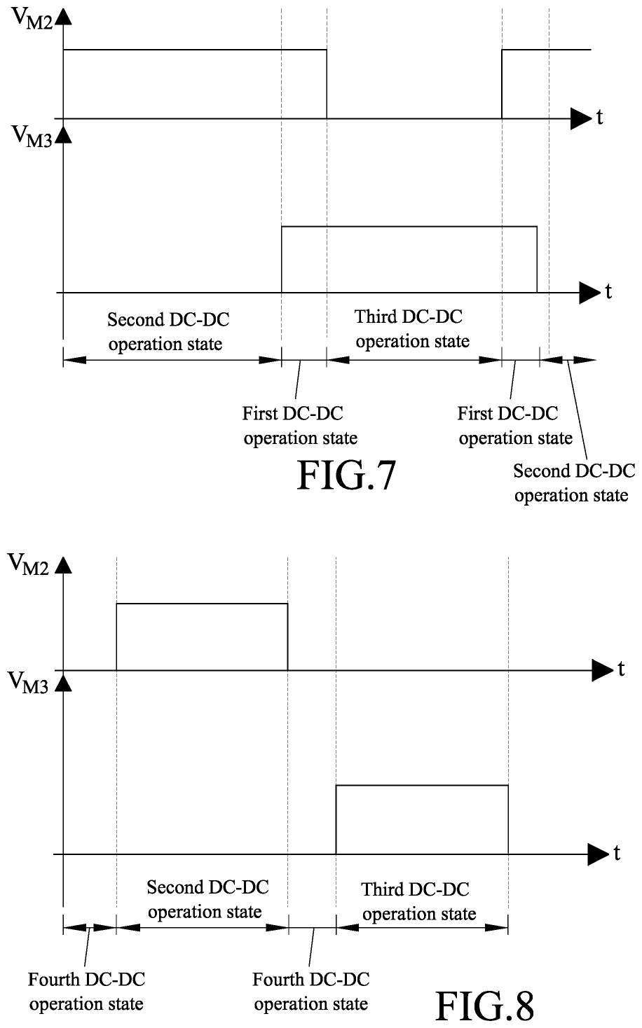

The first converter stage 11 cooperates with the first and second capacitors (C1, C2) to perform DC-to-DC conversion on the DC electric power which is received through the DC power input port (formed by the second terminals of the transistors (M1)) to generate the first-stage DC power output at the first-stage output port. In such a case, the first converter stage 11 operates as an interleaved boost converter circuit, and a single first-stage conversion circuit cell 110 may operate in four operation states as shown in FIG. 4. In a first DC-DC operation state, both of the transistors (M2, M3) conduct; in a second DC-DC operation state, the transistor (M2) conducts while the transistor (M3) does not conduct, thus charging the second capacitor (C2); in a third DC-DC operation state, the transistor (M2) does not conduct while the transistor (M3) conducts, thus charging the first capacitor (C1); and in a fourth DC-DC operation state, both of the transistors (M2, M3) do not conduct, thus charging both of the first and second capacitors (C1, C2). This embodiment may include a controller (not shown) coupled to the control terminal of each of the transistors of this embodiment, and may acquire voltages across the first capacitor (C1) and the second capacitor (C2) via a voltage detector (not shown). When the voltage across the first capacitor (C1) is higher than the voltage across the second capacitor (C2), the first-stage conversion circuit cell 110 may be controlled to operate in a manner as shown in FIG. 5 (note that V_{M2}, V_{M3} respectively represent voltage levels at the control terminals of the transistors (M2, M3)), where the second DC-DC operation state has a longer time length in comparison to the third DC-DC operation state, so as to balance the voltages across the first capacitor (C1) and the second capacitor (C2). When the voltage across the first capacitor (C1) is lower than the voltage across the second capacitor (C2), the first-stage conversion circuit cell 110 may be controlled to operate in a manner as shown in FIG. 6, where the second DC-DC operation state has a shorter time length in comparison to the third DC-DC operation state, so as to balance the voltages across the first capacitor (C1) and the second capacitor (C2). When the voltage across the first capacitor (C1) is equal to the voltage across the second capacitor (C2), the first-stage conversion circuit cell 110 may be controlled to operate in a manner as shown in FIG. 7 or 8, which may be determined based on a magnitude of a voltage of the DC power source (DC1) and a desired magnitude of a voltage across the series connection of the first and second capacitors (C1, C2), where the second and third DC-DC operation states have the same time length. In FIG. 7, the voltage signals at the control terminals of the transistors (M2, M3) have a duty ratio greater than 50%, and in FIG. 8, the voltage signals at the control terminals of the transistors (M2, M3) have a duty ratio smaller than 50%.

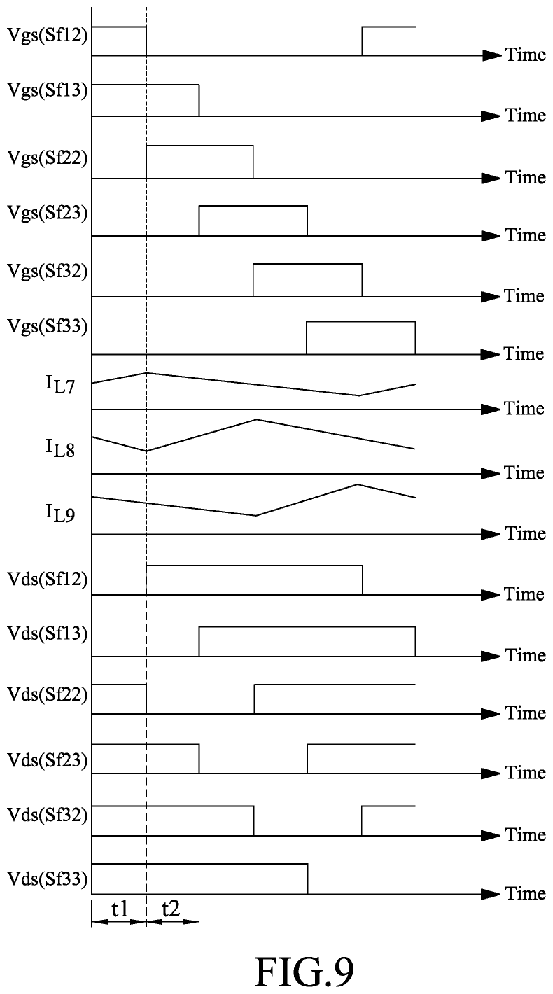

In this embodiment, since the first converter stage 11 includes three first-stage conversion circuit cells 110, FIG. 9 exemplifies an operation sequence regarding the transistors (M2, M3) of the first-stage conversion circuit cells 110, where “Sf12”, “Sf13”, “Sf22”, “Sf23”, “Sf32” and “Sf33” are used to respectively represent the transistors (M2, M3) of a first one (the left one in FIG. 2) of the first-stage conversion circuit cells 110, the transistors (M2, M3) of a second one (the middle one in FIG. 2) of the first-stage conversion circuit cells 110, and the transistors (M2, M3) of a third one (the right one in FIG. 2) of the first-stage conversion circuit cells 110, “Vgs” represents a voltage between the control terminal and the second terminal of the corresponding transistor, “Vds” represent a voltage between the first and second terminals of the corresponding transistor, and “I_{L7}”, “I_{L8}”, “I_{L9}” are used to respectively represent currents flowing through inductors L11 (in order from top to bottom in FIG. 2). In FIG. 9, it can be seen that, during the time period (t1), the first one of the first-stage conversion circuit cells 110 operates in the first operation state (both the transistors (M1, M2) conduct), while the second and third ones of the first-stage conversion circuit cells 110 operate in the fourth operation state (both the transistors (M1, M2) do not conduct), so the second and third ones of the first-stage conversion circuit cells 110 charge the first and second capacitors (C1, C2); and during the time period (t2), the first one of the first-stage conversion circuit cells 110 operates in the third operation state (the transistor (M1) does not conduct and the transistor (M2) conducts), the second one of the first-stage conversion circuit cells 110 operate in the second operation state (the transistor (M1) conducts and the transistor (M2) does not conduct), and the third one of the first-stage conversion circuit cells 110 operates in the fourth operation state (both the transistors (M1, M2) do not conduct), so the first one of the first-stage conversion circuit cells 110 charges the first capacitor (C1), the second one of the first-stage conversion circuit cells 110 charges the second capacitor (C2), and the third one of the first-stage conversion circuit cells 110 charges both the first and second capacitors (C1, C2). It can be seen from FIG. 9 how the first conversion stage 11 performs DC-to-DC conversion.

The second converter stage 12 is coupled to the first-stage output port of the first converter stage for receiving the first-stage DC power output therefrom, and is configured to generate one of a second-stage DC power output, and a second-stage AC power output which contains a number M of AC power output signal(s) each having an individual phase for the AC load (AC2). The second converter stage 12 includes an AC power output port at which the second-stage AC power output is provided, and a DC power output port at which the second-stage DC power output is provided, and a number M of second-stage conversion circuit cell(s) 120. In this embodiment, each second-stage conversion circuit cell 120 has a circuit structure the same as that of the first-stage conversion circuit cell 110, and details thereof are not repeated herein for the sake of brevity. For the second converter stage 12, each of the first terminal(s) of the transistor(s) (M1) of the second-stage conversion circuit cell(s) 120 is coupled to the first terminal(s) of the transistor(s) (M1) of the first-stage conversion circuit cell(s) 110, and each of the second terminals(s) of the transistor(s) (M4) of the second-stage conversion circuit cell(s) 120 is coupled to the second terminal(s) of the transistor(s) (M4) of the first-stage conversion circuit cell(s) 110, thereby receiving the first-stage DC power output therefrom; the AC power output port is formed by the second terminal(s) of the transistor(s) (M2) of the second-stage conversion circuit cell(s) 120 each providing a respective one of the AC power output signal(s) thereat; and the DC power output port is formed by the second terminal(s) of the transistor(s) (M1) of the second-stage conversion circuit cell(s) 120 each providing a portion of the second-stage DC power output thereat.

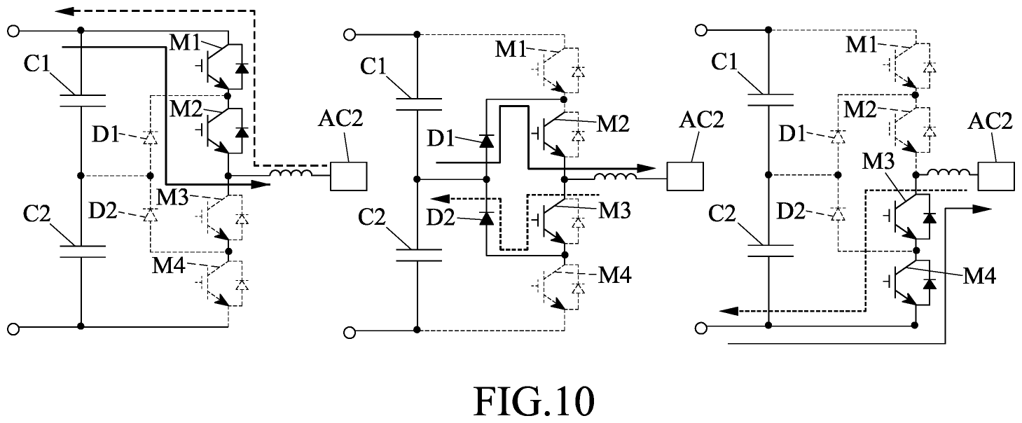

The second converter stage 12 cooperates with the first and second capacitors (C1, C2) to perform DC-to-AC conversion on the first-stage DC power output to generate the second-stage AC power output which is provided to the AC load (AC2) through the second mode switch cell 13 and the load switch cell 3. Referring further to FIG. 10, in such a case, the second converter stage 12 operates as an inverter circuit, and a single second-stage conversion circuit cell 120 may operate in three DC-AC operation states in a specific order.

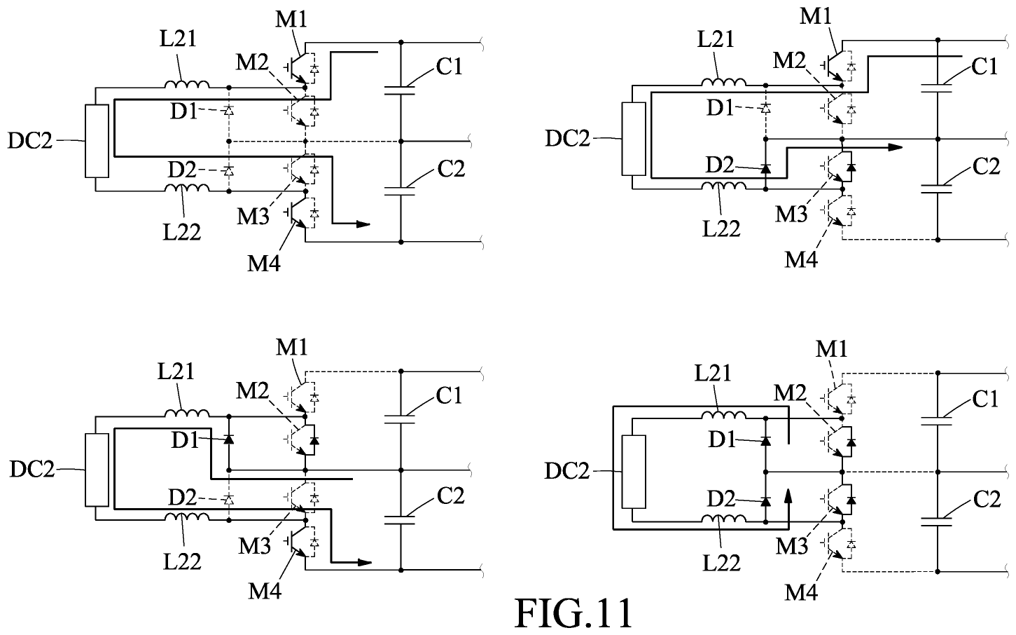

The second converter stage 12 cooperates with the first and second capacitors (C1, C2) to perform DC-to-DC conversion on the first-stage DC power output to generate the second-stage DC power output which is provided to the DC load (DC2) through the second mode switch cell 13 and the load switch cell 3. Referring further to FIG. 11, in such a case, the second converter stage 12 operates as a buck converter circuit, and a single second-stage conversion circuit cell 120 may operate in four DC-DC operation states in a specific order.

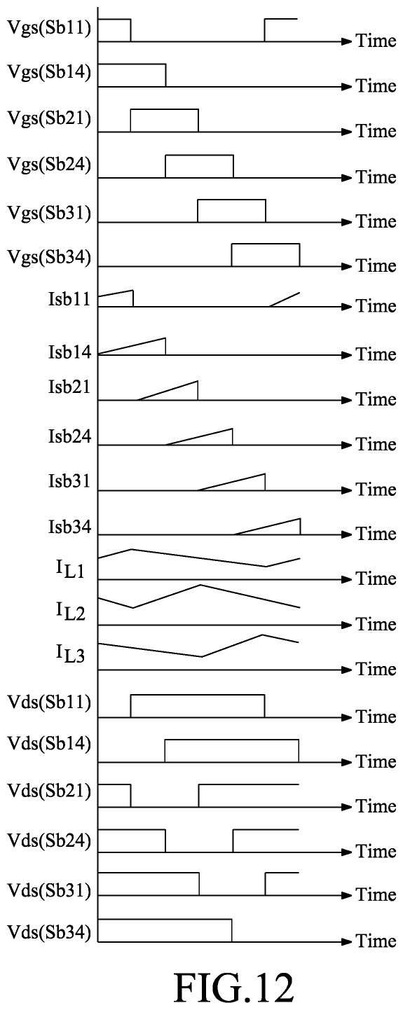

In this embodiment, since the second converter stage 12 includes three second-stage conversion circuit cells 120, FIG. 12 exemplifies an operation sequence regarding the transistors (M1, M4) of the second-stage conversion circuit cells 120, where “Sb11”, “Sb14”, “Sb21”, “Sb24”, “Sb31” and “Sb34” are used to respectively represent the transistors (M1, M4) of a first one (the left one in FIG. 2) of the second-stage conversion circuit cells 120, the transistors (M1, M4) of a second one (the middle one in FIG. 2) of the second-stage conversion circuit cells 120, and the transistors (M1, M4) of a third one (the right one in FIG. 2) of the second-stage conversion circuit cells 120, “Vgs” represents a voltage between the control terminal and the second terminal of the corresponding transistor, “Vds” represent a voltage between the first and second terminals of the corresponding transistor, “L1”, “L2”, “L3” are used to respectively represent inductors L21 (in order from top to bottom in FIG. 2), and “I” represents a current flowing through the corresponding transistor or inductor. It can be seen from FIG. 12 how the second conversion stage 12 performs DC-to-DC conversion.

In this embodiment, each of the transistors (M1, M2, M3, M4) of each of the first-stage conversion circuit cell(s) 110 and the second-stage conversion circuit cell(s) 120 is, but not limited to, an insulated gate bipolar transistor (IGBT) having a collector/drain terminal serving as a first terminal thereof, an emitter/source terminal serving as a second terminal thereof, and a gate terminal serving as a control terminal to receive a respective control signal.

The second mode switch cell 13 includes an AC power input port coupled to the AC power output port of the second converter stage 12 for receiving the second-stage AC power output therefrom, a DC power input port coupled to the DC power output port of the second converter stage for receiving the second-stage DC power output therefrom, and a power output port coupled to the load switch cell 3. The second mode switch cell 13 is operable to couple the power output port thereof to one of the AC power input port thereof and the DC power input port thereof. In this embodiment, the second mode switch cell 13 includes a number M of second mode switch(es) (S13) each having a first terminal (i.e., the node 1 in FIG. 2), a second terminal (the node 2 in FIG. 2) and a third terminal. The first terminal(s) of the second mode switch(es) (S13) forms(form) the AC power input port of the second mode switch cell 13, the second terminal(s) of the second mode switch(es) (S13) forms (form) the DC power input port of the second mode switch cell 13, and the third terminal(s) of the second mode switch(es) (S13) forms(form) the power output port of the second mode switch cell 13. For each second mode switch (S13), the first terminal is coupled to the second terminal of the transistor (M2) of a respective one of the second-stage conversion circuit cell(s) 120 for receiving the respective one of the AC power output signal(s) therefrom, the second terminal is coupled to the second terminal of the transistor (M1) of a respective one of the second-stage conversion circuit cell(s) 120, and the third terminal is coupled to the load switch cell 3 for providing one of a portion of the second-stage DC power output and the respective one of the AC power output signal(s) thereto. Each second mode switch S13 is operable to couple the third terminal thereof to one of the first terminal thereof and the second terminal thereof. In this embodiment, when the power converter is to perform DC-to-AC or AC-to-AC conversion (i.e., the output side of the power converter provides the second-stage AC power output), each second mode switch (S13) is operated to couple the third terminal thereof to the first terminal thereof; and, when the power converter is to perform AC-to-DC or DC-to-DC conversion (i.e., the output side of the power converter provides the second-stage DC power output), each second mode switch (S13) is operated to couple the third terminal thereof to the second terminal thereof.

Since the first conversion stage 11 can selectively perform AC-to-DC or DC-to-DC conversion in cooperation with the first and second capacitors (C1, C2) and the first mode switch cell 10, and the second conversion stage 12 can selectively perform DC-to-AC or DC-to-DC conversion in cooperation of the first and second capacitors (C1, C2) and the second mode switch cell 13, the switchable power converter circuit 1 that combines the first and second mode switch cells 10, 13, the first and second conversion stages 11, 12, and the first and second capacitors (C1, C2) is able to selectively perform the AC-to-AC, AC-to-DC, DC-to-AC and DC-to-DC conversions as desired as long as an appropriate type of power source is connected thereto and the mode switches (S10, S13) are appropriately operated.

The power source switch cell 2 is coupled to the AC power source (AC1) and the DC power source (DC1) for respectively receiving the AC electric power and the DC electric power therefrom, is coupled to the first mode switch cell 10, and is operable to provide one of the AC electric power and the DC electric power to the first mode switch cell 10. In this embodiment, the power source switch cell 2 includes a second-node switch (S20), and a number N of power source switch(es) (S2). The second-node switch (S20) has an input terminal coupled to the second node (−) of the DC power source (DC1), and an output terminal (i.e., node 2 in FIG. 2) coupled to the second terminal(s) of the transistor(s) (M3) of the first-stage conversion circuit cell(s) 110 through inductor(s) (L12). The second-node switch (S20) is operable to make or break electric connection between the input and output terminals thereof. Each power source switch (S2) includes a first terminal (i.e., the node 1 in FIG. 2), a second terminal (i.e., the node 2 in FIG. 2), and a third terminal. For each power source switch (S2), the first terminal is coupled to the AC power source (AC1) for receiving a respective one of the AC power signal(s); the second terminal is coupled to the first node (+) of the DC power source (DC1) for receiving the DC electric power; and the third terminal is coupled to the third terminal of a respective one of the first mode switch(es) (S10) through a respective inductor (L11) for providing one of the DC electric power and the respective one of the AC power signal(s) thereto. Each of the power source switch(es) (S2) is operable to couple the third terminal thereof to one of the first terminal thereof and the second terminal thereof.

The load switch cell 3 is coupled to the AC load (AC2) and the DC load (DC2), is coupled to the second mode switch cell 13 for receiving one of the second-stage AC power output and the second-stage DC power output therefrom, and is operable to provide the received one of the second-stage AC power output and the second-stage DC power output to one of the AC load (AC2) and the DC load (DC2). In this embodiment, the load switch cell 3 includes a second-node switch (S30), and a number M of load switch(es) (S3). The second-node switch (S30) has an input terminal (the node 2 in FIG. 2) coupled to the second terminal(s) of the transistor(s) (M3) of the second-stage conversion circuit cell(s) 120 through inductors (L22), and an output terminal coupled to the second node (−) of the DC load (DC2). The second-node switch (S30) is operable to make or break electric connection between the input and output terminals thereof. Each load switch (S3) includes a first terminal (i.e., the node 1 in FIG. 2), a second terminal (i.e., the node 2 in FIG. 2), and a third terminal. For each load switch (S3), the first terminal is coupled to the AC load (AC2) for providing a respective one of the AC power output signal(s) thereto; the second terminal is coupled to the first node (+) of the DC load (DC2) for providing a portion of the second-stage DC power output thereto; and the third terminal is coupled to the third terminal of a respective one of the second mode switch(es) (S13) through a respective inductor (L21) for receiving one of the portion of the second-stage DC power output and the respective one of the AC power output signal(s) therefrom. Each of the load switch(es) (S3) is operable to couple the third terminal thereof to one of the first terminal thereof and the second terminal thereof.

Based on the abovementioned circuit structure, when the power converter is to perform AC-to-AC conversion, each of the switches S2, S20, S10, S13, S3, S30 is operated to couple the third terminal thereof to the first terminal thereof, so that the first converter stage 11 performs AC-to-DC conversion and the second converter stage 12 performs DC-to-AC conversion; when the power converter is to perform AC-to-DC conversion, each of the switches S2, S20, S10 is operated to couple the third terminal thereof to the first terminal thereof, and each of the switches S3, S30, S13 is operated to couple the third terminal thereof to the second terminal thereof, so that the first converter stage 11 performs AC-to-DC conversion and the second converter stage 12 performs DC-to-DC conversion; when the power converter is to perform DC-to-AC conversion, each of the switches S2, S20, S10 is operated to couple the third terminal thereof to the second terminal thereof, and each of the switches S3, S30, S13 is operated to couple the third terminal thereof to the first terminal thereof, so that the first converter stage 11 performs DC-to-DC conversion and the second converter stage 12 performs DC-to-AC conversion; and when the power converter is to perform DC-to-DC conversion, each of the switches S2, S20, S10, S13, S3, S30 is operated to couple the third terminal thereof to the second terminal thereof, so that the first converter stage 11 performs DC-to-DC conversion and the second converter stage 12 performs DC-to-DC conversion.

In this embodiment, since N=M, the power converter is configured to have a structure substantially symmetric with respect to the first and second capacitors (C1, C2) from the perspective of operation of the power converter. It is noted herein that the term “substantially” is used because connection between the first mode switch cell 10 and the first converter stage 11 may be different from connection between the second mode switch cell 12 and the second converter stage 13; however, the same switching function is achieved. For example, in FIG. 2, the first and second terminals of each of the upper and lower first mode switches (S10) are coupled to different first-stage conversion circuit cells 110, and the first and second terminals of each second mode switch (S13) are coupled to the same second-stage conversion circuit cell 120. However, for the first/second mode switches (S10/S13), the first terminals thereof are respectively coupled to different first/second-stage conversion circuit cells 110/120, and the second terminals thereof are respectively coupled to different first/second-stage conversion circuit cells 110/120, so the same switch function is achieved from the perspective of operation of the power converter.

In addition, it can be understood from the previous description that both of the first and second converter stages 11, 12 are bidirectional, so that the entire power converter of this embodiment is bidirectional. Accordingly, the power converter shown in FIG. 2 can be used in an opposite way and still has the same function, which means that the power converter can receive AC or DC electric power from the right side of FIG. 2, and output the desired AC or DC power to the left side of FIG. 2. In consideration of the bidirectional operation and the four switchable power conversion modes, the power converter can be used in eight different ways.

It is noted that the embodiment of the power converter employs the neutral point clamped structure which may induce lower voltage stress for each transistor, thereby reducing switching loss of the transistors.

In the description above, for the purposes of explanation, numerous specific details have been set forth in order to provide a thorough understanding of the embodiment(s). It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A power converter comprising:
a first mode switch cell including a power input port disposed to receive one of alternating-current (AC) electric power provided by an AC power source and direct-current (DC) electric power provided by a DC power source, an AC power output port, and a DC power output port, said first mode switch cell being operable to couple said power input port to one of said AC power output port and said DC power output port; and
a converter circuit including a first converter stage that includes an AC power input port coupled to said AC power output port of said first mode switch cell, a DC power input port coupled to said DC power output port of said first mode switch cell, and a first-stage output port;
wherein said first converter stage is configured to generate a first-stage DC power output at said first-stage output port by:
performing AC-to-DC conversion on the AC electric power which is received through said AC power input port to generate the first-stage DC power output; and
performing DC-to-DC conversion on the DC electric power which is received through said DC power input port to generate the first-stage DC power output.

2. The power converter of claim 1, the AC electric power provided by the AC power source including a number N of AC power signal(s) each having an individual phase, N being a positive integer, wherein said converter circuit further includes a first capacitor having a first terminal and a second terminal, and a second capacitor having a first terminal coupled to said second terminal of said first capacitor, and a second terminal;
wherein said first converter stage includes:
a number N of first-stage conversion circuit cell(s) each including:
a first transistor having a first terminal coupled to said first terminal of said first capacitor, a second terminal coupled to said DC power input port, and a control terminal;
a second transistor having a first terminal coupled to said second terminal of said first transistor, a second terminal coupled to said AC power input port for receiving a respective one of the AC power signal(s) therefrom, and a control terminal;
a third transistor having a first terminal coupled to said second terminal of said second transistor, a second terminal, and a control terminal;
a fourth transistor having a first terminal coupled to said second terminal of said third transistor, a second terminal coupled to said second terminal of said second capacitor, and a control terminal;
a first diode having a cathode coupled to said second terminal of said first transistor, and an anode coupled to said second terminal of said first capacitor; and
a second diode having a cathode coupled to said anode of said first diode, and an anode coupled to said second terminal of said third transistor;
wherein said first terminal(s) of said first transistor(s) and said second terminal(s) of said second fourth transistor(s) of said first-stage conversion circuit cell(s) cooperatively provide the first-stage DC power output.

3. The power converter of claim 2, wherein said first mode switch cell includes a number N of first mode switch(es) each having:
a first terminal coupled to said second terminal of said second transistor of a respective one of said first-stage conversion circuit cell(s);
a second terminal coupled to said second terminal of said first transistor of a respective one of said first-stage conversion circuit cell(s); and
a third terminal disposed to receive one of the DC electric power provided by the DC power source and a respective one of the AC power signal(s);
wherein each of said first mode switch(es) is operable to couple said third terminal thereof to a same one of said first terminal thereof and said second terminal thereof.

4. The power converter of claim 3, further comprising a power source switch cell to be coupled to the AC power source and the DC power source for respectively receiving the AC electric power and the DC electric power therefrom, coupled to said first mode switch cell, and operable to provide one of the AC electric power and the DC electric power to said first mode switch cell.

5. The power converter of claim 4, wherein said power source switch cell includes a number N of power source switch(es) each including:
a first terminal to be coupled to the AC power source for receiving a respective one of the AC power signal(s);
a second terminal to be coupled to the DC power source for receiving the DC electric power; and
a third terminal coupled to said third terminal of a respective one of said first mode switch(es) for providing one of the DC electric power provided by the DC power source and the respective one of the AC power signal(s) thereto;
wherein each of said power source switch(es) is operable to couple said third terminal thereof to a same one of said first terminal thereof and said second terminal thereof.

6. The power converter of claim 5, wherein said first mode switch cell and said power source switch cell are configured such that each of said first mode switch(es) couples said third terminal thereof to said first terminal thereof when each of said power source switch(es) couples said third terminal thereof to said first terminal thereof, and that each of said first mode switch(es) couples said third terminal thereof to said second terminal thereof when each of said power source switch(es) couples said third terminal thereof to said second terminal thereof.

7. The power converter of claim 6, the DC power source having a first node and a second node that cooperatively provide the DC electric power, wherein:
said second terminal of each of said power source switch(es) is to be coupled to the first node of the DC power source; and
said power source switch cell further includes a second-node switch having an input terminal to be coupled to the second node of the DC power source, and an output terminal coupled to said second terminal of said third transistor of each of said first-stage conversion circuit cell(s) of said first converter stage, said power source switch cell being operable to make electric connection between said input and output terminals thereof when each of said power source switch(es) couples said third terminal thereof to said second terminal thereof, and to break electric connection between said input and output terminals thereof when each of said power source switch(es) couples said third terminal thereof to said first terminal thereof.

8. The power converter of claim 3, wherein said converter circuit further includes a second converter stage coupled to said first-stage output port of said first converter stage for receiving the first-stage DC power output therefrom, configured to generate one of a second-stage AC power output and a second-stage DC power output, and including an AC power output port at which the second-stage AC power output is provided, and a DC power output port at which the second-stage DC power output is provided;
said power converter further comprising:
a second mode switch cell including an AC power input port coupled to said AC power output port of said second converter stage for receiving the second-stage AC power output therefrom, a DC power input port coupled to said DC power output port of said second converter stage for receiving the second-stage DC power output therefrom, and a power output port to be coupled to one of an AC load and a DC load, said second mode switch cell being operable to couple said power output port to one of said AC power input port and said DC power input port;
wherein said second converter stage is configured to perform DC-to-AC conversion on the first-stage DC power output to generate the second-stage AC power output which is provided to said power output port of said second mode switch cell through said AC power input port of said second mode switch cell; and
wherein said second converter stage is configured to perform DC-to-DC conversion on the first-stage DC power output to generate the second-stage DC power output which is provided to said power output port of said second mode switch cell through said DC power input port of said second mode switch cell.

9. The power converter of claim 8, wherein the second-stage AC power output includes a number M of AC power output signal(s) each having an individual phase for the AC load, M being a positive integer, wherein said second converter stage includes:
a number M of second-stage conversion circuit cell(s) each including:
a first transistor having a first terminal coupled to said first terminal of said first capacitor, a second terminal coupled to said DC power output port, and a control terminal;
a second transistor having a first terminal coupled to said second terminal of said first transistor of said second-stage conversion circuit cell, a second terminal coupled to said AC power output port for providing a respective one of the AC power output signal(s) thereto, and a control terminal;
a third transistor having a first terminal coupled to said second terminal of said second transistor of said second-stage conversion circuit cell, a second terminal, and a control terminal;
a fourth transistor having a first terminal coupled to said second terminal of said third transistor of said second-stage conversion circuit cell, a second terminal coupled to said second terminal of said second capacitor, and a control terminal;
a first diode having a cathode coupled to said second terminal of said first transistor of said second-stage conversion circuit cell, and an anode coupled to said second terminal of said first capacitor; and
a second diode having a cathode coupled to said anode of said first diode, and an anode coupled to said second terminal of said third transistor of said second-stage conversion circuit cell.

10. The power converter of claim 9, wherein said second mode switch cell includes a number M of second mode switch(es) each having:
a first terminal coupled to said second terminal of said second transistor of a respective one of said second-stage conversion circuit cell(s);
a second terminal coupled to said second terminal of said first transistor of a respective one of said second-stage conversion circuit cell(s); and
a third terminal to be coupled to one of the DC load and the AC load for providing one of a portion of the second-stage DC power output and a respective one of the AC power output signal(s) thereto;
wherein each of said second mode switch(es) is operable to couple said third terminal thereof to a same one of said first terminal thereof and said second terminal thereof.

11. The power converter of claim 10, further comprising a load switch cell to be coupled to the AC load and the DC load, coupled to said second mode switch cell for receiving one of the second-stage AC power output and the second-stage DC power output therefrom, and operable to provide the one of the second-stage AC power output and the second-stage DC power output to one of the AC load and the DC load.

12. The power converter of claim 11, wherein said load switch cell includes a number M of load switch(es) each including:
a first terminal to be coupled to the AC load for providing a respective one of the AC power output signal(s) thereto;
a second terminal to be coupled to the DC load for providing a portion of the second-stage DC power output thereto; and
a third terminal coupled to said third terminal of a respective one of said second mode switch(es) for receiving the one of the portion of the second-stage DC power output and the respective one of the AC power output signal(s) therefrom;
wherein each of said load switch(es) is operable to couple said third terminal thereof to a same one of said first terminal thereof and said second terminal thereof.

13. The power converter of claim 12, wherein said second mode switch cell and said load switch cell are configured such that each of said second mode switch(es) couples said third terminal thereof to said first terminal thereof when each of said load switch(es) couples said third terminal thereof to said first terminal thereof, and that each of said second mode switch(es) couples said third terminal thereof to said second terminal thereof when each of said load switch(es) couples said third terminal thereof to said second terminal thereof.

14. The power converter of claim 13, the DC load having a first node and a second node that cooperatively receive the second-stage DC power output, wherein:
said second terminal of each of said load switch(es) is to be coupled to the first node of the DC load; and
said load switch cell further includes a second-node switch having an output terminal to be coupled to the second node of the DC load, and an input terminal coupled to said second terminal of said third transistor of each of said second-stage conversion circuit cell(s) of said second converter stage, and is operable to make electric connection between said input and output terminals thereof when each of said load switch(es) couples said third terminal thereof to said second terminal thereof, and to break electric connection between said input and output terminals thereof when each of said load switch(es) couples said third terminal thereof to said first terminal thereof.

15. The power converter of claim 1, wherein said converter circuit further includes a second converter stage coupled to said first-stage output port of said first converter stage for receiving the first-stage DC power output therefrom, configured to generate one of a second-stage AC power output and a second-stage DC power output, and including an AC power output port at which the second-stage AC power output is provided, and a DC power output port at which the second-stage DC power output is provided;
said power converter further comprising:
a second mode switch cell including an AC power input port coupled to said AC power output port of said second converter stage for receiving the second-stage AC output therefrom, a DC power input port coupled to said DC power output port of said second converter stage for receiving the second-stage DC output therefrom, and a power output port to be coupled to one of an AC load and a DC load, said second mode switch cell being operable to couple said power output port to one of said AC power input port and said DC power input port;
wherein said second converter stage is configured to perform DC-to-AC conversion on the first-stage DC power output to generate the second-stage AC power output which is provided to said power output port of said second mode switch cell through said AC power input port of said second mode switch cell; and
wherein said second converter stage is configured to perform DC-to-DC conversion on the first-stage DC power output to generate the second-stage DC power output which is provided to said power output port of said second mode switch cell through said DC power input port of said second mode switch cell.

16. The power converter of claim 15, wherein said converter circuit further includes:
a first capacitor having a first terminal coupled to said first converter stage, and a second terminal; and
a second capacitor having a first terminal coupled to said second terminal of said first capacitor, and a second terminal coupled to said first converter stage;
wherein the second-stage AC power output includes a number M of AC power output signal(s) each having an individual phase for the AC load, M is a positive integer, and said second converter stage includes:
a number M of second-stage conversion circuit cell(s) each including:
a first transistor having a first terminal coupled to said first terminal of said first capacitor, a second terminal coupled to said DC power output port, and a control terminal;
a second transistor having a first terminal coupled to said second terminal of said first transistor of said second-stage conversion circuit cell, a second terminal coupled to said AC power output port for providing a respective one of the AC power output signal(s) thereto, and a control terminal;
a third transistor having a first terminal coupled to said second terminal of said second transistor of said second-stage conversion circuit cell, a second terminal, and a control terminal;
a fourth transistor having a first terminal coupled to said second terminal of said third transistor of said second-stage conversion circuit cell, a second terminal coupled to said second terminal of said second capacitor, and a control terminal;
a first diode having a cathode coupled to said second terminal of said first transistor of said second-stage conversion circuit cell, and an anode coupled to said second terminal of said first capacitor; and
a second diode having a cathode coupled to said anode of said first diode, and an anode coupled to said second terminal of said third transistor of said second-stage conversion circuit cell;
wherein said first terminal(s) of said first transistor(s) and said second terminal(s) of said second fourth transistor(s) of said second-stage conversion circuit cell(s) cooperate to receive the first-stage DC power output.

17. The power converter of claim 16, wherein said second mode switch cell includes a number M of second mode switch(es) each having:
a first terminal coupled to said second terminal of said second transistor of a respective one of said second-stage conversion circuit cell(s);
a second terminal coupled to said second terminal of said first transistor of a respective one of said second-stage conversion circuit cell(s); and
a third terminal to be coupled to one of the DC load and the AC load for providing one of a portion of the second-stage DC power output and a respective one of the AC power output signal(s) thereto;
wherein each of said second mode switch(es) is operable to couple said third terminal thereof to a same one of said first terminal thereof and said second terminal thereof.

18. A power converter comprising:
a converter circuit disposed to receive direct-current (DC) power provided by a DC power source, configured to generate one of an alternating-current (AC) power output and a DC power output, and including an AC power output port at which the AC power output is provided, and a DC power output port at which the DC power output is provided; and
a mode switch cell including an AC power input port coupled to said AC power output port of said converter circuit for receiving the AC power output therefrom, a DC power input port coupled to said DC power output port of said converter circuit for receiving the DC power output therefrom, and a power output port to be coupled to one of an AC load and a DC load, said second mode switch cell being operable to couple said power output port to one of said AC power input port and said DC power input port;
wherein said converter circuit is configured to perform DC-to-AC conversion on the DC power to generate the AC power output which is provided to said power output port of said mode switch cell through said AC power input port of said mode switch cell; and
wherein said converter circuit is configured to perform DC-to-DC conversion on the DC power to generate the DC power output which is provided to said power output port of said mode switch cell through said DC power input port of said mode switch cell.

19. The power converter of claim 18, wherein the AC power output includes a number M of AC power output signal(s) each having an individual phase for the AC load, M being a positive integer, wherein said converter stage includes:
a first capacitor having a first terminal and a second terminal;
a second capacitor having a first terminal that is coupled to said second terminal of said first capacitor, and a second terminal that cooperates with the first terminal of said first capacitor to receive the DC power; and
a number M of conversion circuit cell(s) each including:
a first transistor having a first terminal coupled to said first terminal of said first capacitor, a second terminal coupled to said DC power output port, and a control terminal;
a second transistor having a first terminal coupled to said second terminal of said first transistor, a second terminal coupled to said AC power output port for providing a respective one of the AC power output signal(s) thereto, and a control terminal;
a third transistor having a first terminal coupled to said second terminal of said second transistor, a second terminal, and a control terminal;
a fourth transistor having a first terminal coupled to said second terminal of said third transistor, a second terminal coupled to said second terminal of said second capacitor, and a control terminal;
a first diode having a cathode coupled to said second terminal of said first transistor, and an anode coupled to said second terminal of said first capacitor; and
a second diode having a cathode coupled to said anode of said first diode, and an anode coupled to said second terminal of said third transistor.

20. The power converter of claim 19, wherein said mode switch cell includes a number M of mode switch(es) each having:
a first terminal coupled to said second terminal of said second transistor of a respective one of said conversion circuit cell(s);
a second terminal coupled to said second terminal of said first transistor of a respective one of said conversion circuit cell(s); and
a third terminal to be coupled to one of the DC load and the AC load for providing one of a portion of the DC power output and a respective one of the AC power output signal(s) thereto;
wherein each of said mode switch(es) is operable to couple said third terminal thereof to a same one of said first terminal thereof and said second terminal thereof.
